(19) United States
(12) Patent Application Publication
(10) Pub. No.: US 2006/0117185 A1
(43) Pub. Date: Jun. 1, 2006

(54) Timestamp administration system and image forming apparatus

(75) Inventors: Satoshi Oguri, Osaka-shi (JP); Kenichi Mizusu, Osaka-shi (JP); Manami Kawamoto, Osaka-shi (JP); Toshinobu Yoshida, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 11/284,316

(22) Filed: Nov. 21, 2005

(30) Foreign Application Priority Data
Nov. 30, 2004 (JP) 2004-347046

(51) Int. Cl. H04L 9/00

(52) U.S. Cl. 713/178

(57) ABSTRACT

A timestamp administration system includes: a timestamp information acquiring section which acquires timestamp information via a network from a timestamp organization of verifying the time; an approval requesting section which requests approval of acquiring the timestamp information by the timestamp information acquiring section; an approval party information storage which stores information relating to a party to which the approval is requested by the approval requesting section; and a controlling section which causes the approval requesting section to request the approval party stored in the approval party information storage of the approval, and causes the timestamp information acquiring section to acquire the timestamp information if it is judged that the approval requesting section has received the approval from the approval party.

### BACKGROUND OF THE INVENTION

1. Field of the Invention

The present invention relates to a timestamp administration system for administrating acquisition of timestamp information issued from a timestamp organization, and to an image forming apparatus equipped with the timestamp administration system.

2. Description of the Related Art

Heretofore, there has been known a timestamp service for electronically verifying the date and time when an electronic document has been created to prevent falsification of the electronic document or the like. The timestamp service is operated in such a manner that a user accesses a timestamp organization such as a timestamp authority which provides a timestamp service via a network on his or her personal computer, and receives verification regarding the time when an electronic document has been created by issuance of timestamp information. Japanese Unexamined Patent Publication No. 2003-323512 proposes an example of a printing system utilizing the timestamp service. In the printing system, a user requests a timestamp authority of issuance of a timestamp in printing a document, so that the timestamp issued in response to the request is printed along with the document.

Since the timestamp organization charges for the timestamp service, it costs high if all the documents to be printed are printed with the timestamp under the timestamp service. The arrangement recited in the above publication has not taken a measure for suppressing the cost relating to the timestamp service at the time of printing a document.

### SUMMARY OF THE INVENTION

In view of the above problems residing in the prior art, it is an object of the present invention to provide a timestamp administration system that enables to suppress the cost relating to processing of data utilizing the timestamp service, and an image forming apparatus provided with the timestamp administration system.

An aspect of the invention is directed to a timestamp administration system comprising: a timestamp information acquiring section which acquires timestamp information via a network from a timestamp organization of verifying the time; an approval requesting section which requests approval of acquiring the timestamp information by the timestamp information acquiring section; an approval party information storage which stores information relating to a party to which the approval is requested by the approval requesting section; and a controlling section which causes the approval requesting section to request the approval party stored in the approval party information storage of the approval, and causes the timestamp information acquiring section to acquire the timestamp information if it is judged that the approval requesting section has received the approval from the approval party.

In the above arrangement, in acquiring timestamp information by the timestamp information acquiring section, the controlling section, first, causes the approval requesting section to request the approval party stored in the approval party storage of the approval, and causes the timestamp information acquiring section to acquire the timestamp information if it is judged that the approval requesting section has received the approval from the approval party.

According to the above arrangement, a constraint is made, in which a user is allowed to acquire the timestamp information only in the condition that the approval requesting section has received the approval from the predetermined approval party, without allowing all the possible users to utilize the timestamp service all the time in processing data. This enables to restrain the number of times of utilizing the timestamp service, which contributes to cost reduction relating to processing of data utilizing the timestamp service.

These and other objects, features and advantages of the present invention will become more apparent upon reading of the following detailed description along with the accompanying drawings.

### BRIEF DESCRIPTION OF THE DRAWINGS

FIG. 1 is an illustration showing a network configuration comprised of an image forming apparatus to which a timestamp administration system of the invention is applied, and a computer system connected to the image forming apparatus.

FIG. 2 is a block diagram schematically showing an internal arrangement of a complex machine as an example of the image forming apparatus shown in FIG. 1.

FIG. 3 is a block diagram schematically showing an internal configuration of a personal computer shown in FIG. 1.

FIG. 4 is a block diagram schematically showing an internal configuration of a server computer shown in FIG. 1.

FIGS. 5A and 5B are flowcharts showing a first embodiment of timestamp administration used in the complex machine shown in FIG. 1 in storing data of a read document image.

FIGS. 6A and 6B are flowcharts showing a second embodiment of timestamp administration used in the complex machine shown in FIG. 1 in storing data of a read document image.

FIGS. 7A and 7B are flowcharts showing a third embodiment of timestamp administration used in the complex machine shown in FIG. 1 in storing data of a read document image.

FIGS. 8A and 8B are flowcharts showing a fourth embodiment of timestamp administration used in the complex machine shown in FIG. 1 in the case where data is outputted.

### DETAILED DESCRIPTION OF THE PREFERRED EMBODIMENTS

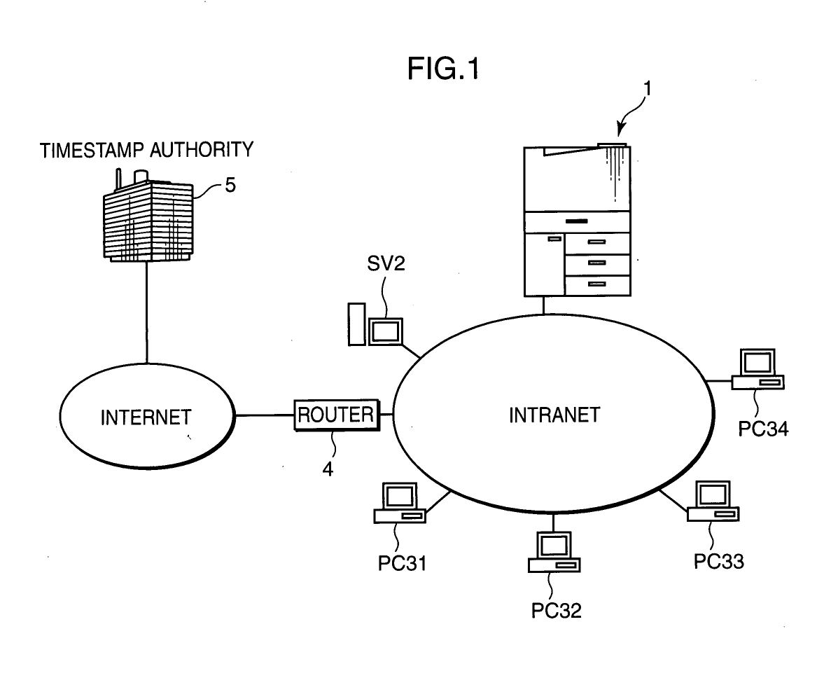

In the following, description is made, referring to the drawings, on a timestamp administration system as an embodiment of the invention, and an image forming apparatus to which the timestamp administration system is applied. FIG. 1 is an illustration showing a network configuration comprised of the image forming apparatus to which the timestamp administration system is applied, and a computer system connected to the image forming apparatus.

A complex machine 1 as an example of the image forming apparatus has functions of a copier, a fax, a printer, and a scanner or the like. The complex machine 1 is constructed in such a manner that data of a document image read by a scanner is stored in a hard disk drive of the complex machine 1, or in respective storages of a server computer SV2, and personal computers PC31 through PC34 connected to the complex machine 1 via an intranet or the like. The complex machine 1 is also operative to print out data stored in the hard disk drive of the complex machine 1 or print out data transmitted from the server computer SV2 or the personal computers PC31 through PC34. The complex machine 1, the server computer SV2, and the personal computers PC31 through PC34 are communicable with each other by a so-called workflow system. The workflow system is a system for supporting a user or operator in carrying out a task by automating a flow of control operations of the task in accordance with a predetermined procedure.

Also, the network comprised of the complex machine 1, the server computer SV2, and the personal computers PC31 through PC34 are connected to the Internet via a router 4. The complex machine 1 is constructed in such a manner that a user is allowed to access a timestamp authority 5 as an example of a timestamp organization, and to indirectly via the server computer SV2 or directly receive a timestamp service provided by the timestamp authority 5 of electronically verifying the date and time when an electronic document has been created, or an e-mail sent from an external personal computer or a like device.

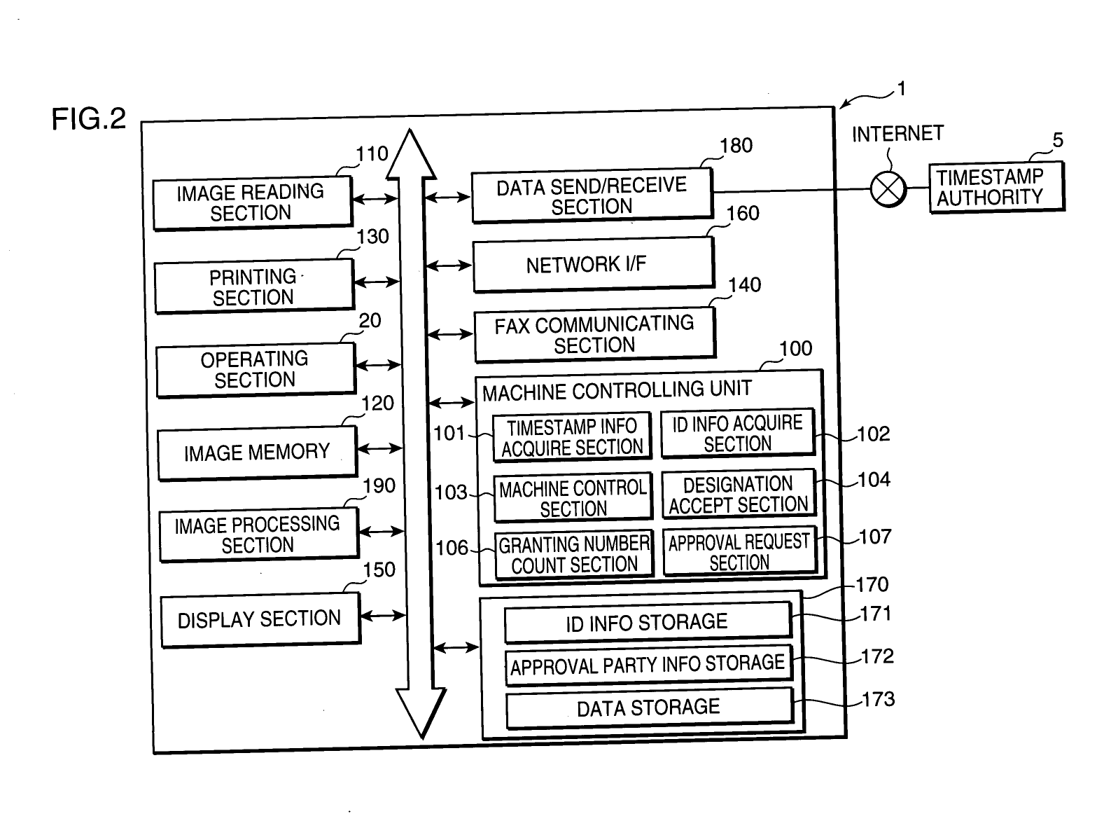

FIG. 2 is a block diagram schematically showing an internal arrangement of the complex machine 1. The complex machine 1 includes a machine controlling unit 100 for controlling operations of the respective components of the complex machine 1, an image reading section 110 provided with the scanner for reading a document image, an image memory 120 for temporarily storing data of the document image read by the image reading section 110, and a printing section 130 for printing the document data read by the image reading section 110 or data stored in a data storage 173 of a hard disk drive 170 (called as “machine HDD 170”) of the complex machine 1. The image reading section 110 is an example of a data input accepting section, and the printing section 130 is an example of a confirmation message outputting section or a data outputting section.

Also, the complex machine 1 includes: a facsimile communicating section 140 for executing various functions necessary for facsimile communication, and for receiving image data from an external facsimile device via a public telephone line; an operating section 20, which is provided with a data transmission start key, a ten key, and an index key, and which is adapted to accept user's designation relating to various operations such as the number of copies to be printed, and input of ID information, which will be described later; and a machine display section 150 provided with a liquid crystal display (LCD) for displaying an operation guidance for the user. The machine display section 150 is an example of the confirmation message outputting section or the data outputting section. The machine display section 150 may have a touch panel function so that the user's designation relating to various operations including input of the ID information is accepted.

The machine HDD 170 has an ID information storage 171, an approval party information storage 172, and the data storage 173. The ID information storage 171 stores one or more identification (ID) information for which acquiring of timestamp information by the timestamp information acquiring section 101 is granted or approved.

The approval party information storage 172 stores one or more information relating to a party to which approval of acquiring timestamp information by the timestamp information acquiring section 101 is requested. The approval party information includes, for instance, an address, on a network, of a personal computer (in this embodiment, PC31 through PC34) allocated to a user or an operator who is designated as the approval party. In this embodiment, an approval requesting section 107 performs data communication with one or more approval parties stored in the approval party information storage 172 via the server computer SV2 to request approval of acquiring timestamp information.

The data storage 173 is a storage for storing data read by the image reading section 110, data to be printed by the printing section 130, and the like.

Referring to FIG. 2, the machine controlling unit 100 includes the timestamp information acquiring section 101, the ID information acquiring section 102, a machine controlling section 103, a designation accepting section 104, a granting number counting section 106, and the approval requesting section 107.

The timestamp information acquiring section 101 is operative to acquire timestamp information from the timestamp authority 5 via the Internet. The timestamp information is information for electronically verifying the date and time when an electronic document has been created, and is sometimes simply called as a timestamp.

The ID information acquiring section 102 is operative to acquire ID information sent from the operating section 20 or the machine display section 150 in response to user's manipulation on the operating section 20 or the touch panel function of the machine display section 150. The ID information is allocated to individual users of the complex machine 1 to identify the individual users of the complex machine 1. The ID information is used to determine whether a specific user is required to acquire approval in acquiring timestamp information from the timestamp authority 5 by the timestamp information acquiring section 101.

The machine controlling section 103 is operative to control an overall control operation of the complex machine 1. Also, the machine controlling section 103 causes the approval requesting section 107 to request the approval party stored in the approval party information storage 172 of the approval, and causes the timestamp information acquiring section 101 to acquire timestamp information if the approval requesting section 107 has received the approval from the approval party. The respective controls to be performed by the machine controlling section 103 will be described later one by one referring to the flowcharts.

The designation accepting section 104 is operative to accept designation relating to processing of data, which is entered by the user by way of the operating section 20, the touch panel function of the machine display section 150, or the personal computers PC31 through PC 34. The designation includes designation for storing or printing data read by the image reading section 110, and designation for printing data stored in the data storage 173 of the machine HDD 170.

The granting number counting section 106 is operative to count the accumulative number of times of acquiring timestamp information by the timestamp information acquiring section 101 with respect to each of the ID information acquired by the ID information acquiring section 102.

The approval requesting section 107 is operative to request one or more approval parties indicated by the approval party information stored in the approval party information storage 172, e.g. the personal computers PC31 through PC34 in this embodiment, of approval in acquiring timestamp information from the timestamp authority 5 by the timestamp information acquiring section 101. The approval request by the approval requesting section 107 is implemented by data communication according to the aforementioned workflow system.

Also, the complex machine 1 includes an image processing section 190 for performing editing/processing of image data read by the image reading section 110, such as coding/decoding, enlargement/reduction, and compression/decompression, and a network interface (I/F) 160, which is used for various data communication with the server computer SV2 and the personal computers PC31 through PC34.

The data sending/receiving section 180 is operative to request the timestamp authority 5 of timestamp information via the Internet, and to send/receive the timestamp information as requested under the control of the machine controlling section 103. Also, the data sending/receiving section 180 has a function of sending and receiving an e-mail to and from an external personal computer or a like device via the Internet. The router 4 is not illustrated in FIG. 2.

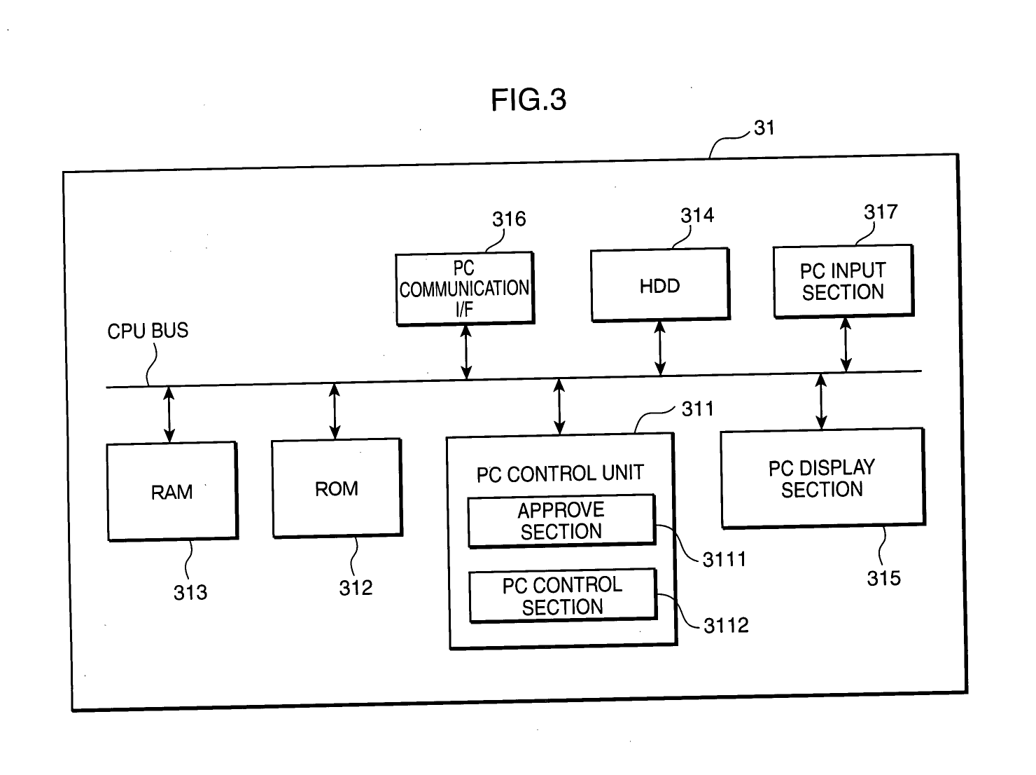

FIG. 3 is a block diagram schematically showing an internal configuration of the personal computer PC31, PC32, PC33, PC34. Since the arrangements of the personal computers PC31 through PC34 are substantially identical to each other, description is made by taking an example of the arrangement of the personal computer PC31. The personal computer PC31 includes a PC controlling unit 311, a PC ROM 312, a PC RAM 313, a PC HDD 314, a PC display section 315, a PC communication I/F 316, and a PC inputting section 317.

The PC controlling unit 311 has an approving section 3111 and a PC controlling section 3112. The approving section 3111 is operative to send information indicating approval in response to an approval request from the complex machine 1 by data communication according to the workflow system. The PC controlling section 3112 controls an overall control operation of the personal computer PC31.

The PC ROM 312 stores various operation programs for the personal computer PC31. The PC RAM 313 is used as a work area or the like for the PC controlling unit 311. The PC HDD 314 is a storage for storing various data for the personal computer PC31. The PC display section 315 displays the contents of various data, such as a message indicating that the complex machine 1 is requesting approval of acquiring timestamp information, and a message prompting the user of the personal computer PC31 to enter approval or non-approval to the request. The PC communication I/F 316 functions as an interface for data communication with the complex machine 1 and the server computer SV2. The PC inputting section 317 is constituted of a keyboard and a mouse, and is used to enter designation on approval or non-approval by the user.

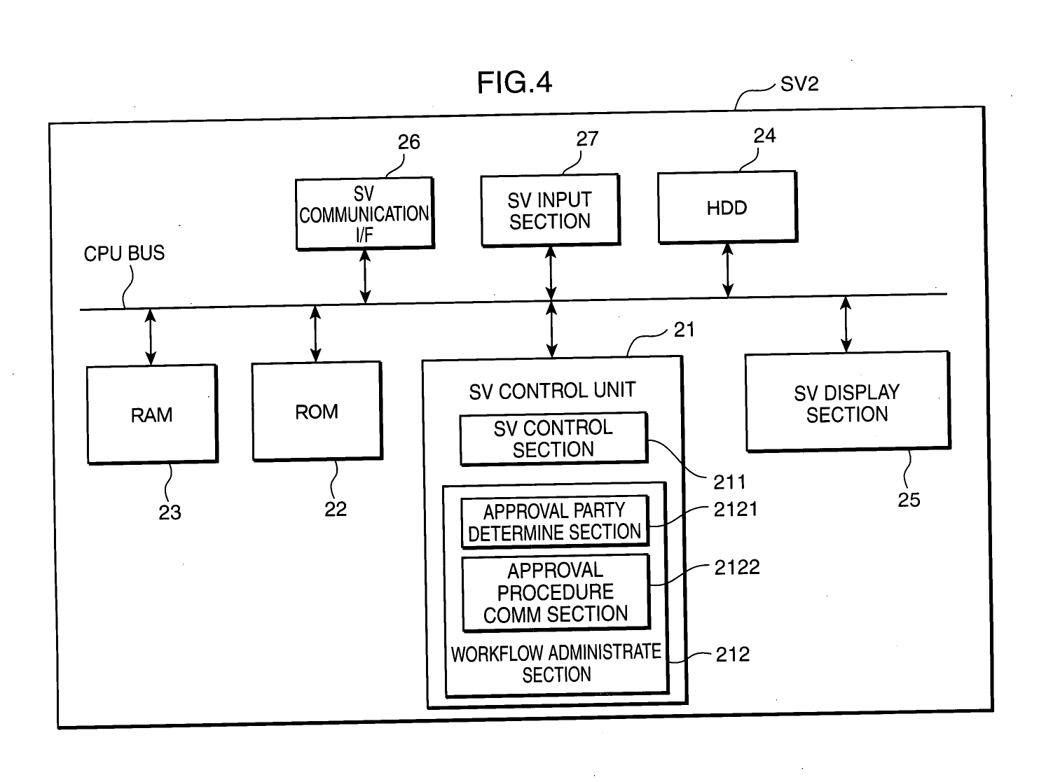

FIG. 4 is a block diagram schematically showing an internal configuration of the server computer SV2. The server computer SV2 includes an SV controlling unit 21, an SV ROM 22, an SV RAM 23, an SV HDD 24, an SV display section 25, an SV communication I/F 26, and an SV inputting section 27. The SV controlling unit 21 has an SV controlling section 211, and a workflow administrating section 212.

The SV controlling section 211 controls an overall control operation of the server computer SV2. The workflow administering section 212 is operative to communicate electronically processed information with the personal computers PC31 through PC34 interconnected to each other on the intranet, based on an execution program of the workflow system stored in the SV HDD 24. In this embodiment, communication at least concerning request of approving acquisition of timestamp information, and approval/non-approval of the request is performed with the complex machine 1, and the personal computers PC31 through PC34.

The workflow administrating section 212 has an approval party identifying section 2121 and an approval procedure communicating section 2122 to implement the workflow process. The approval party determining section 2121 is operative to determine the approval party which is qualified to give approval in acquiring timestamp information by the timestamp information acquiring section 101 of the complex machine 1 among the personal computers PC31 through PC34 interconnected to each other on the intranet, based on the approval party information sent from the complex machine 1. The approval procedure communicating section 2122 is operative to send information indicating the approval request to the personal computer PC31, PC32, PC33, or PC34 which is determined to be the approval party by the approval party determining section 2121, to receive a reply, namely, approval or non-approval to the request, and to transfer the reply to the complex machine-1.

The SV ROM 22 stores various operation programs for the server computer SV2. The SV RAM 23 is used as a work area or the like for the SV controlling section 211. The SV HDD 24 is a storage for storing various data for the server computer SV2. In this embodiment, a program necessary for executing the workflow system is stored in the SV HDD 24. Alternatively, it is possible to store the program in the SV ROM 22. The SV display section 25 displays the contents of various data for the server computer SV2. The SV communication I/F 26 functions as an interface for data communication with the complex machine 1 and the personal computers PC31 through PC34. The SV inputting section 27 is constituted of a keyboard and a mouse.

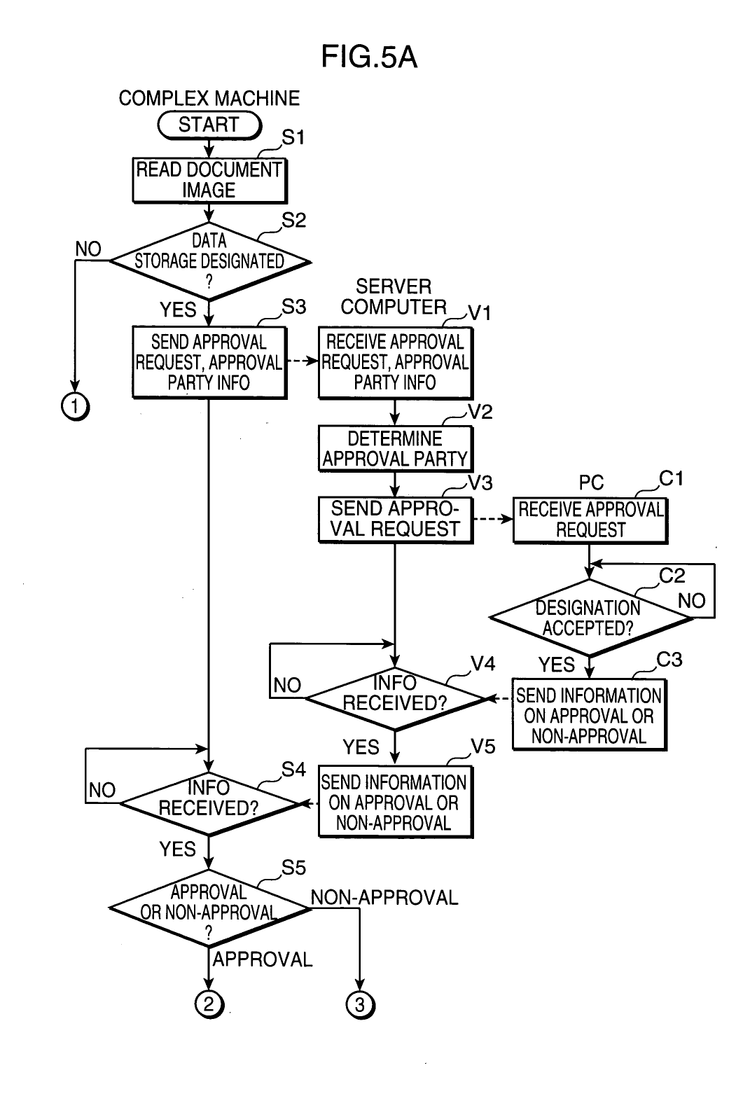

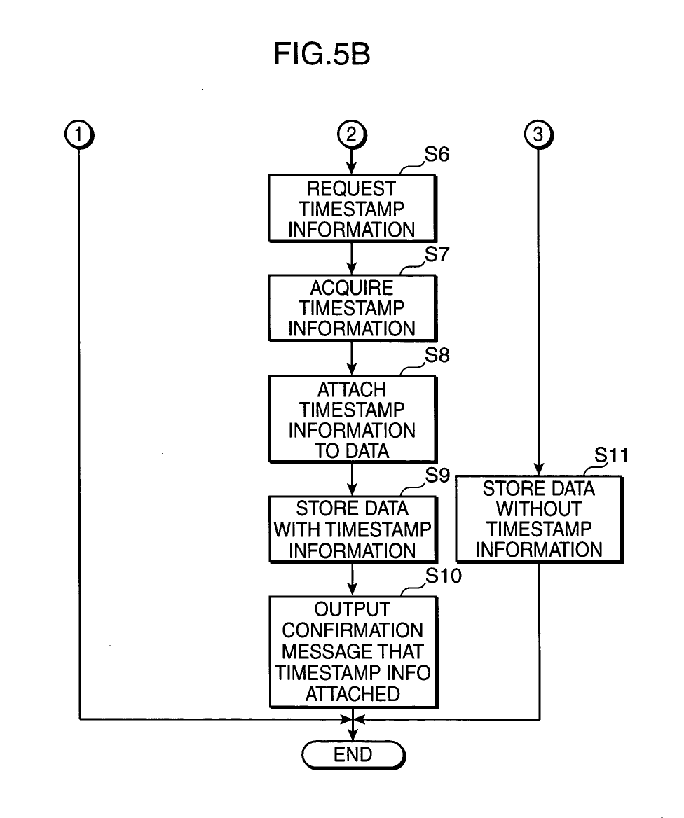

Now, a first embodiment of timestamp administration to be implemented by the complex machine 1 is described referring to FIGS. 5A and 5B. FIGS. 5A and 5B are flowcharts showing the first embodiment of timestamp administration in the case where the complex machine 1 is so designed as to store data of a document image read by the image reading section 110. Steps to be implemented by the complex machine 1 are denoted by S1, S2, . . . , steps to be implemented by the server computer SV2 are denoted by V1, V2, . . . , and steps to be implemented by the personal computer PC31, PC32, PC33, or PC34 are denoted by C1, C2, throughout the first to fourth embodiments of the invention. When a document image is read by the image reading section 110 (Step S1), and designation to store data of the document image into the data storage 173 of the machine HDD 170 is entered by the user by way of the operating section 20 (YES in Step S2), the approval requesting section 107 sends a request for approval of acquiring timestamp information, as well as information relating to the approval party to the server computer SV2 via the network I/F 160 (Step S3). If there is no designation from the user to store the data after the reading of the document image (NO in Step S2), the routine ends.

When the approval procedure communicating section 2122 of the SV controlling unit 21 of the server computer SV2 receives the request for approval and the information relating to the approval party from the complex machine 1 via the SV communication I/F 26 (Step V1), the approval party determining section 2121 determines the approval party to which the approval is requested based on the information relating to the approval party (Step V2). In this embodiment, the approval party is one of the personal computers PC31 through PC34 interconnected to each other on the intranet. The approval party represented by the approval party information may be one or more. When the approval party determining section 2121 determines one of the personal computers PC31 through PC34 as the approval party, the approval procedure communicating section 2122 requests the personal computer PC31, PC32, PC33, or PC34 designated as the approval party of approval in acquiring timestamp information (Step V3). Hereinafter, in this example, description is made based on a premise that the personal computer PC31 is determined and designated as the approval party.

When the approving section 3111 of the PC controlling unit 311 of the personal computer PC31 receives the approval request from the server computer SV2 via the PC communication I/F 316 (Step C1), the PC controlling section 3112 displays, on the PC display section 315, a message prompting the user to enter designation regarding approval or non-approval of the request. If the user of the personal computer PC31 enters the designation regarding approval or non-approval of the request, and the designation is accepted by the approving section 3111 (YES in Step C2), the approving section 3111 sends information representing approval or non-approval to the server computer SV2 (Step C3).

When the approval procedure communicating section 2122 of the server computer SV2 receives the information representing approval or non-approval (YES in Step V4), the approval procedure communicating section 2122 sends the information representing approval or non-approval to the complex machine 1, which has sent the approval request and the information relating to the approval party to the server computer SV2 (see Step S3 and Step V1) (Step V5).

Subsequently, when the approval requesting section 107 of the complex machine 1 receives the information representing approval or non-approval from the server computer SV2 (YES in Step S4), the machine controlling section 103 judges whether the information represents approval or non-approval to the request of acquiring timestamp information (Step S5). If it is judged that the information represents non-approval to the request (NON-APPROVAL in Step S5), acquisition of timestamp information is not implemented, and the machine controlling section 103 stores the data without timestamp information in the data storage 173 (Step S11). Thus, the routine ends.

If, on the other hand, the information represents approval to the request (APPROVAL in Step S5), the timestamp information acquiring section 101 requests the timestamp authority 5 of timestamp information via the data sending/receiving section 180 (Step S6).

When the timestamp information acquiring section 101 acquires the timestamp information as requested from the timestamp authority 5 via the data sending/receiving section 180 (Step S7), the machine controlling section 103 attaches the timestamp information acquired by the timestamp information acquiring section 101 to the data obtained in Step S1 (Step S8). Then, the machine controlling section 103 stores the data with the timestamp information being attached thereto in the data storage 173 (Step S9). After the data storage, the machine controlling section 103 causes the printing section 130 to print a confirmation message indicating that the timestamp information has been attached to the data at the time of the data storage (Step S10) to notify the user that the timestamp information has been attached, and the routine ends. Alternatively, the machine controlling section 103 may cause the machine display section 150 to display the confirmation message, in place of causing the printing section 130 to print the confirmation message.

In this way, a constraint is made, in which timestamp information is acquired, namely, the timestamp service is utilized only in the condition that the approval request in acquiring timestamp information is approved by the approval party stored in the approval party information storage 172 of the complex machine 1, without allowing all the possible users to utilize the timestamp service all the time in storing data read by the image reading section 110. This arrangement enables to restrain the number of times of utilizing the timestamp service, which contributes to cost reduction in processing of data utilizing the timestamp service. For instance, in the case where the network system incorporated with the complex machine 1 is used in a company or the like, the network system is operative to cause individual workers of the company to automatically request his or her supervisor or administrator of approval in utilizing the timestamp service by designating a personal computer of the supervisor or administrator as the approval party stored in the approval party information storage 172. This arrangement is also advantageous in allowing the supervisor or administrator to grasp the status of the individual workers concerning utilization of the timestamp service, and to promptly decide approval or non-approval to the request.

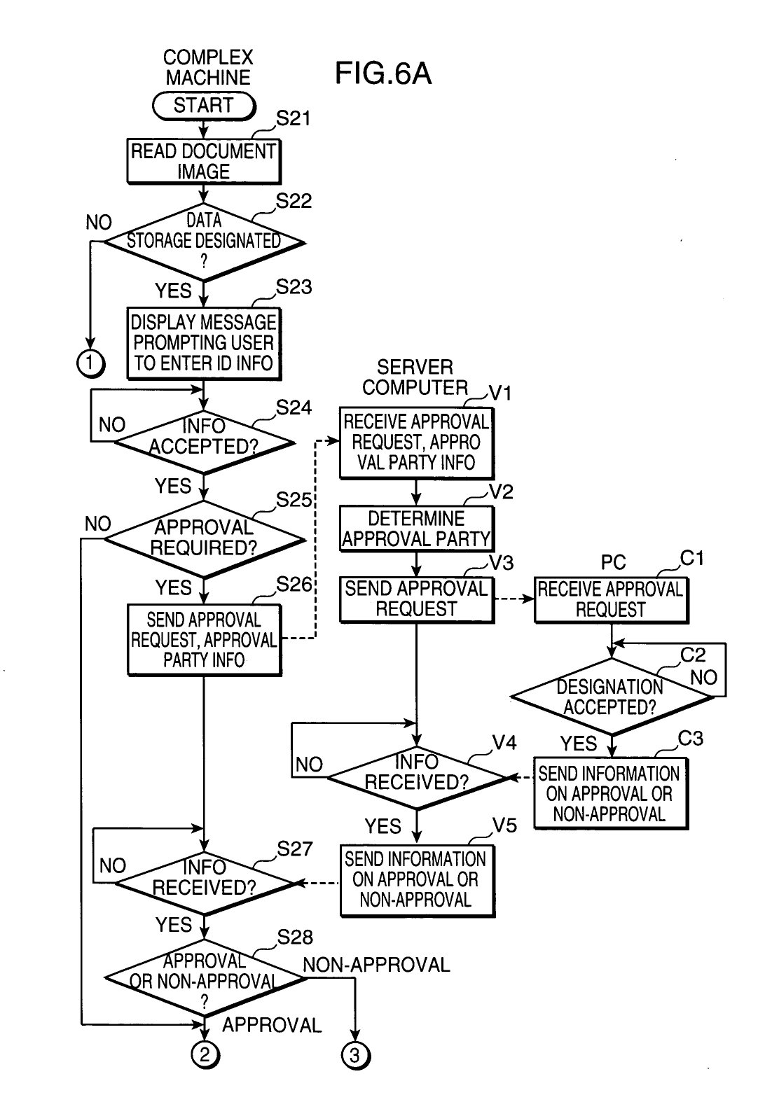

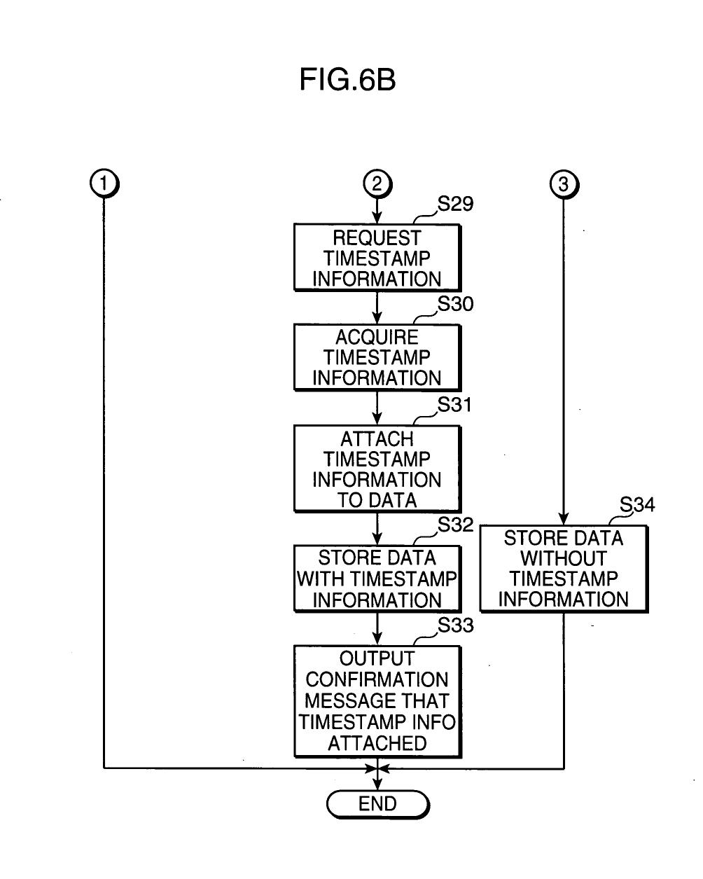

Next, a second embodiment of timestamp administration to be implemented by the complex machine 1 is described referring to FIGS. 6A and 6B. FIGS. 6A and 6B are flowcharts showing the second embodiment of timestamp administration in the case where data of a document image read by the image reading section 110 is stored. Unless otherwise specifically mentioned, operations to be implemented in FIGS. 6A and 6B which are identical to those in FIGS. 5A and 5B are denoted by the same step numbers in FIGS. 6A and 6B. The same idea is applied to the third and the fourth embodiments.

In the second embodiment, a judgment is made as to whether approval in acquiring timestamp information is required with respect to each of the ID information allocated to individual users of the complex machine 1 so that the request is required exclusively for a specific user having a specific ID information, without making all the possible users request approval in utilizing the timestamp service.

When a document image is read by the image reading section 110 (Step S21), and when designation to store data of the document image in the data storage 173 of the machine HDD 170 is entered by the user by way of the operating section 20 or the like (YES in Step S22), the machine controlling section 103 causes the machine display section 150 to display a message prompting the user to enter his or her ID information (Step S23) If the ID information is entered by manipulation of the user on the operating section 20, and the machine controlling section 103 accepts the designation (YES in Step S24), the machine controlling section 103 judges whether the accepted ID information indicating that approval is required in acquiring timestamp information is stored in the ID information storage 171 (Step S25).

If it is judged that the accepted ID information indicating that approval is required is stored in the ID information storage 171 (YES in Step S25), the approval requesting section 107 sends, to the server computer SV2, the approval request and the information relating to the approval party (Step S26). If the request is approved (APPROVAL in Step S28), the timestamp information acquiring section 101 acquires timestamp information (Steps S27 through S30), followed by attaching of the acquired timestamp information to the data, storing of the data with the timestamp information being attached thereto, and outputting of a confirmation message indicating that the data has been received (Steps S31 through S33), and the routine ends. If, on the other hand, the request is not approved (NON-APPROVAL in Step S28), acquisition of timestamp information is not implemented, and the data without timestamp information is stored in the data storage 173 (Step S34). Thus the routine ends.

If it is judged that the accepted ID information does not indicate that approval in acquiring timestamp information is required, namely, the ID information indicating that approval is required in acquiring timestamp information is not stored in the ID information storage 171 (NO in Step S25), the machine controlling section 103 causes the timestamp information acquiring section 101 to acquire timestamp information (Steps S29 and S30) while skipping the operations in Steps S26 through 28 for approval. Then, after implementing Steps S31 through S33, the routine ends.

According to the second embodiment, a judgment is made as to whether approval in acquiring timestamp information is required with respect to each of the individual users, which provides a flexible criteria concerning granted use of the timestamp service.

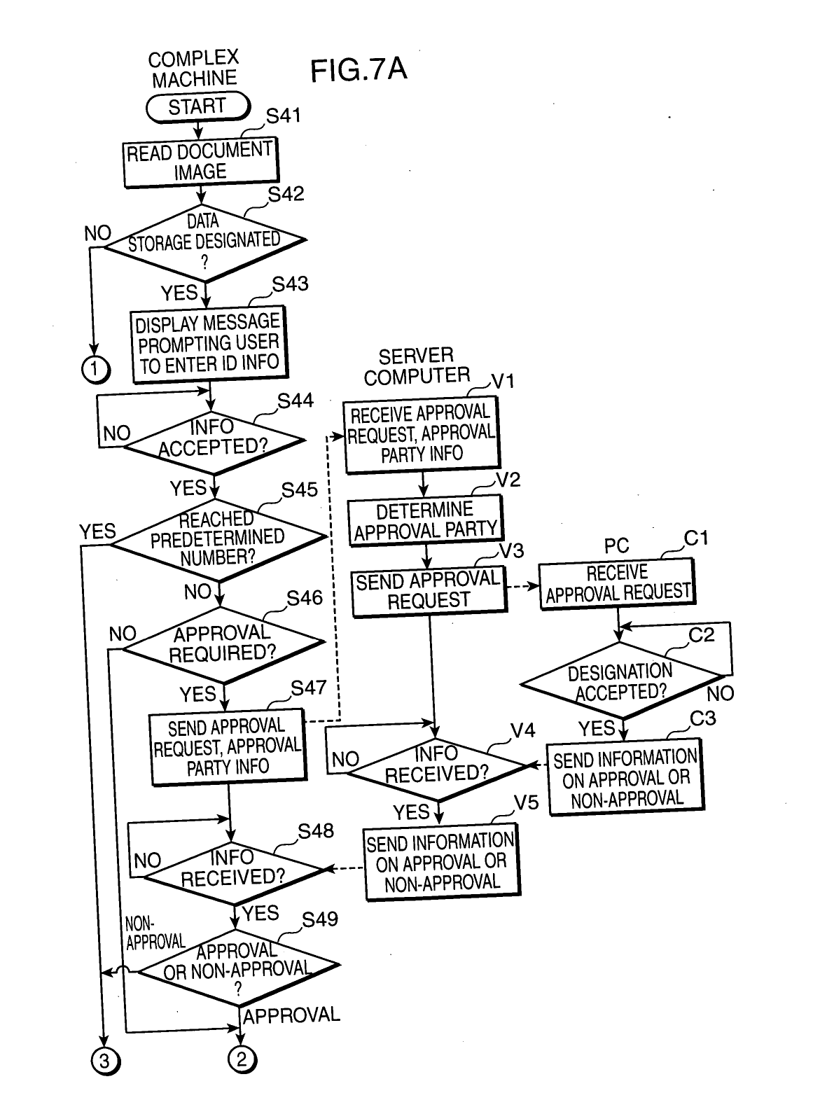

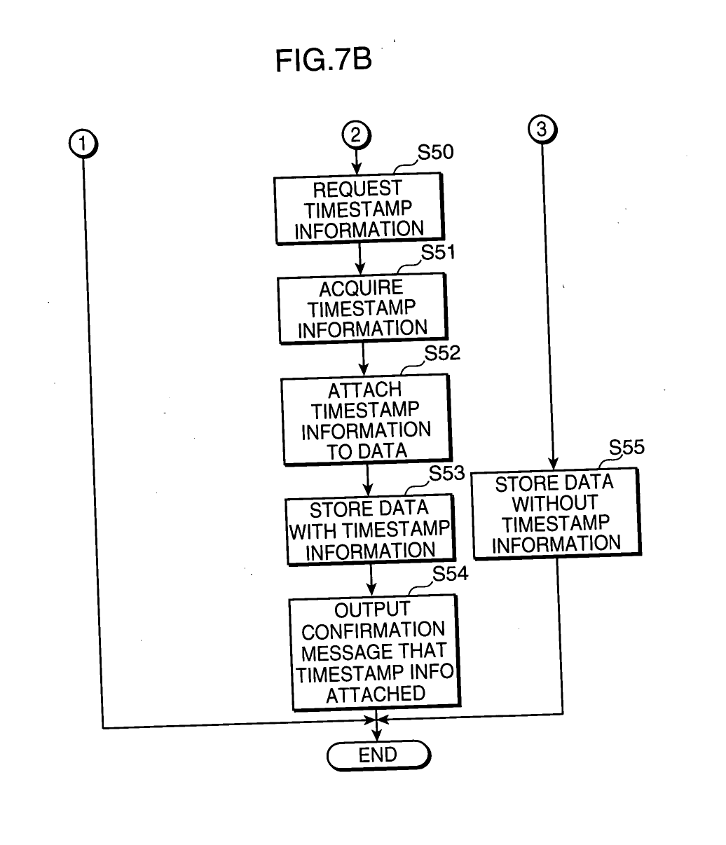

Next, a third embodiment of timestamp administration to be implemented by the complex machine 1 is described referring to FIGS. 7A and 7B. FIGS. 7A and 7B are flowcharts showing the third embodiment of timestamp administration in the case where data of a document image read by the image reading section 110 is stored. Merely the operations necessary for describing the features of the third embodiment are described referring to FIGS. 7A and 7B, and description on operations identical or equivalent to those in FIGS. 5A, 5B, 6A, and 6B is omitted herein.

The third embodiment has a feature that acquisition of timestamp information is not approved or granted if the accumulative number of times of acquiring timestamp information using the ID information entered by the individual users has reached a predetermined number.

When the ID information is entered by the user (YES in Step S44), the machine controlling section 103 judges whether the accumulative number of times of acquiring timestamp information using the ID information has reached a predetermined number e.g. 10 times a month based on the count value counted by the granting number counting section 106 (Step S45). If it is judged that the accumulative number of times of acquiring timestamp information has reached the predetermined number (YES in Step S45), acquisition of timestamp information is not implemented, and the machine controlling section 103 stores the data without timestamp information in the data storage 173 (Step S55).

If, on the other hand, the accumulative number of times of acquiring timestamp information using the ID information has not reached the predetermined number (NO in Step S45), the machine controlling section 103 judges whether the accepted ID information requires approval in acquiring timestamp information (Step S46). If it is judged that the accepted ID information requires approval (YES in Step S46), the machine controlling section 103 causes the timestamp information acquiring section 101 to acquire timestamp information upon receiving approval from a predetermined approval party (Steps S47 through S51).

Then, the machine controlling section 103 is operative to attach the timestamp information acquired by the timestamp information acquiring section 101 to the data obtained in Step S41 (Step S52). Although not shown in FIGS. 7A and 7B, the granting number counting section 106 counts up the number of times of acquiring timestamp information with respect to the ID information. Subsequently, the machine controlling section 103 stores the data with the timestamp information being attached thereto in the data storage 173 (Step S53). After the data storage, the machine controlling section 103 causes the printing section 130 to print a confirmation message indicating that timestamp information has been attached to the data at the time of the data storage to notify the user that the timestamp information has been attached (Step S54), and the routine ends. Alternatively, the machine controlling section 103 may cause the machine display section 150 to output e.g. to display a confirmation message, in place of causing the printing section 130 to print the confirmation message.

If the judgment result in Step S49 indicates non-approval (NON-APPROVAL in Step S49), data without timestamp information is stored in the data storage 173 (Step S55), and the routine ends.

According to the third embodiment, a constraint is made regarding acquisition of timestamp information in terms of the number of times of acquiring timestamp information with respect of each of the individual users, which provides a flexible criteria concerning granted use of the timestamp service.

In the third embodiment, a constraint is made regarding the number of times of acquiring timestamp information irrespective of the ID information of the individual users. Alternatively, in the operation of Step S45, a constraint may be made regarding the number of times of acquiring timestamp information with respect to each of the ID information based on a predetermined allowable number of times of acquiring timestamp information with respect to each of the ID information.

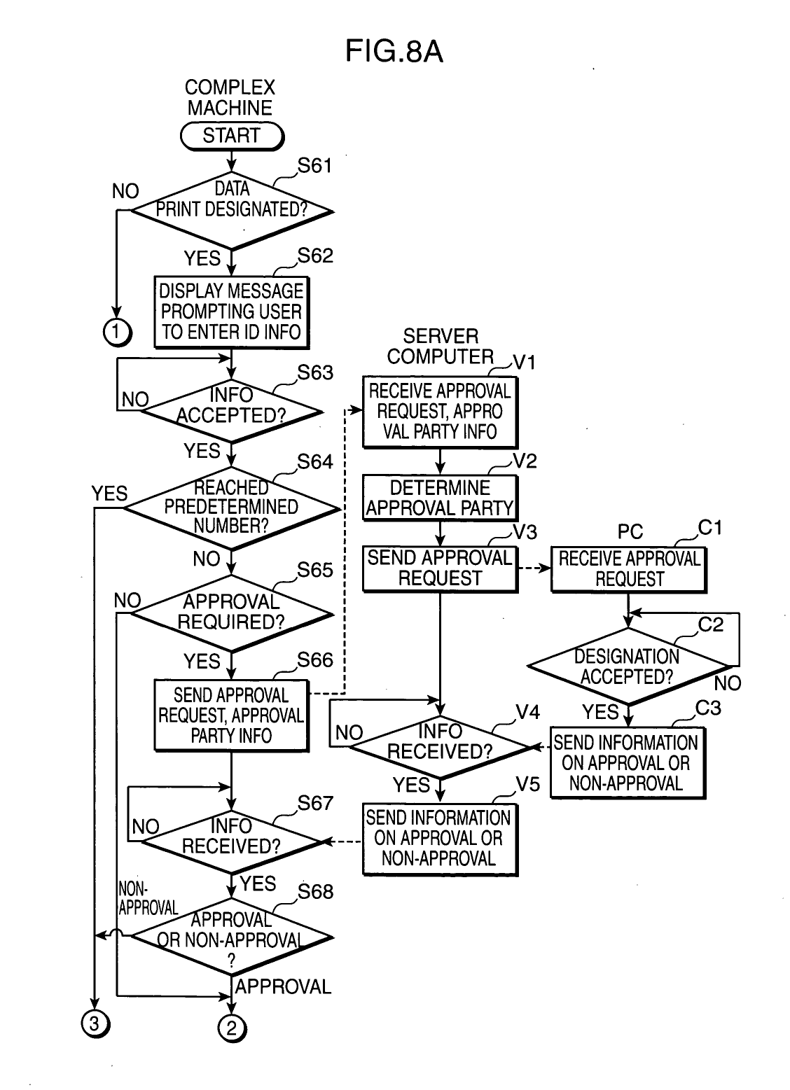

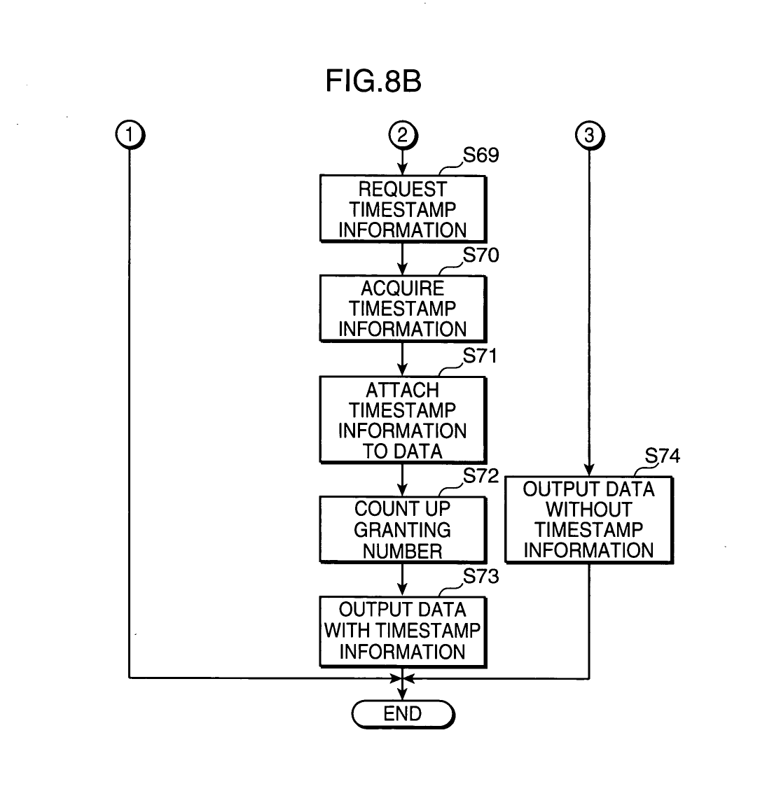

Next, a fourth embodiment of timestamp administration to be implemented by the complex machine 1 is described referring to FIGS. 8A and 8B. FIGS. 8A and 8B are flowcharts showing the fourth embodiment of timestamp administration in the case where the complex machine 1 is so designed as to output data. Merely the operations necessary for describing the features of the fourth embodiment are described referring to FIGS. 8A and 8B, and description on operations identical or equivalent to those in FIGS. 5A, 5B, 6A, 6B, 7A, and 7B is omitted herein.

The fourth embodiment is directed to timestamp administration in the case where data stored in the data storage 173 of the machine HDD 170 is readout for printing. When designation to print the data stored in the data storage 173 of the machine HDD 170 is entered by the user on the operating section 20 or the like (YES in Step S61), the machine controlling section 103 causes the machine display section 150 to display a message prompting the user to enter his or her ID information (Step S62). When the ID information is entered by the user (YES in Step S63), the machine controlling section 103 judges whether the accumulative number of times of acquiring timestamp information using the ID information has reached a predetermined number e.g. 10 times a month based on the count value counted by the granting number counting section 106 (Step S64).

If it is judged that the accumulative number of times of acquiring timestamp information using the ID information has not reached the predetermined number (NO in Step S64), the machine controlling section 103 judges whether the accepted ID information requires approval in acquiring timestamp information (Step S65). If it is judged that approval is required (YES in Step S65), the machine controlling section 103 causes the timestamp information acquiring section 101 to acquire timestamp information upon receiving approval from a predetermined approval party (Steps S66 through S70). Then, the machine controlling section 103 is operative to attach the timestamp information acquired by the timestamp information acquiring section 101 to the data to be printed (Step S71), cause the granting number counting section 106 to count up the number of times of acquiring timestamp information regarding the ID information (Step S72), and cause the printing section 130 to print the data with the timestamp information being attached thereto (Step S73). Thus, the routine ends.

If, on the other hand, it is judged that the accumulative number of times of acquiring timestamp information using the ID information has reached the predetermined number (YES in Step S64), or if the request to acquire timestamp information is not approved (NON-APPROVAL in Step S68), the machine controlling section 103 causes the printing section 130 to print out the data without timestamp information (Step S74), and the routine ends.

A series of operations shown in the fourth embodiment is applicable not only to a case of printing out data stored in the data storage 173 of the machine HDD 170 but also to a case of printing out data sent from the personal computers PC31 through PC34 interconnected to each other on the intranet.

Also, in the fourth embodiment, a judgment is made as to whether approval request is conducted with respect to each of the ID information. Alternatively, in place of or in addition to the judgment based on the individual ID information, it is possible to judge whether approval request is conducted based on individual data, namely, in accordance with the kind of data to be processed in Step S61, for instance, based on (i) a judgment as to whether the data stored in the data storage 173 of the machine HDD 170 is printed out or the data sent from the personal computers PC31 through PC34 is printed out, or based on (ii) the kind of image data such as JPEG, BMP, and GIF, and the kind of data compatible with individual software applications.

According to the fourth embodiment, a constraint is made regarding utilization of timestamp service in outputting or printing out data read by the image reading section 110, which contributes to cost reduction in utilizing the timestamp service. Also, this arrangement provides flexible administration in utilizing the timestamp service such as administration in utilizing the timestamp service with respect to each of the individual users, and a constraint in acquiring timestamp information in terms of the number of times of acquiring timestamp information with respect to each of the users.

The invention is not limited to the foregoing, and various modifications are applicable as far as such modifications do not depart from the gist of the invention. In the embodiments, for instance, description is made on the arrangement in which the inventive timestamp administration system is applied to the complex machine 1. The inventive timestamp administration system is not specifically limited to the complex machine 1. Alternatively, it is possible to apply the inventive timestamp administration system to an image forming apparatus other than the complex machine 1.

Also, the arrangements and the processes shown in FIGS. 1 through 8B are merely examples of the invention. The invention is not limited to the aforementioned arrangements and processes.

This application is based on Japanese Patent Application No. 2004-347046 filed on Nov. 30, 2004, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. A timestamp administration system comprising:
a timestamp information acquiring section which acquires timestamp information via a network from a timestamp organization of verifying the time;
an approval requesting section which requests approval of acquiring the timestamp information by the timestamp information acquiring section;
an approval party information storage which stores information relating to a party to which the approval is requested by the approval requesting section; and
a controlling section which causes the approval requesting section to request the approval party stored in the approval party information storage of the approval, and causes the timestamp information acquiring section to acquire the timestamp information if it is judged that the approval requesting section has received the approval from the approval party.

2. The timestamp administration system according to claim 1, further comprising:
a data input accepting section which accepts input of data;
a data storage which stores the data accepted by the data input accepting section; and
a designation accepting section which accepts designation relating to processing of the data, wherein
the controlling section causes the approval requesting section to request the approval, causes the timestamp information acquiring section to acquire the timestamp information in response to receiving the approval, and causes the data storage to store the data with the acquired timestamp information being attached thereto if it is judged that the designation accepting section has accepted the designation to store the data in the data storage.

3. The timestamp administration system according to claim 2, further comprising:
a confirmation message outputting section which outputs a confirmation message indicating that the data with the timestamp information being attached thereto is stored in the data storage, wherein
the controlling section causes the confirmation message outputting section to output the confirmation message if it is judged that the data with the timestamp information being attached thereto is stored in the data storage.

4. The timestamp administration system according to claim 1, further comprising:
a data storage which stores data;
a data outputting section which outputs the data stored in the data storage; and
a designation accepting section which accepts designation relating to processing of the data, wherein
the controlling section causes the approval requesting section to request the approval, causes the timestamp information acquiring section to acquire the timestamp information in response to receiving the approval, and causes the data outputting section to output the data with the acquired timestamp information being attached thereto if it is judged that the designation accepting section has accepted the designation to output the data stored in the data storage by the data outputting section.

5. The timestamp administration system according to claim 1, further comprising:
an ID information acquiring section which acquires ID information for identifying a user based on an external output and
an ID information storage which stores the one or more ID information for which request of the approval by the approval requesting section is required, wherein
the controlling section causes the approval requesting section to request the approval, and causes the timestamp information acquiring section to acquire the timestamp information in response to receiving the approval if it is judged that the ID information acquired by the ID information acquiring section is stored in the ID information storage.

6. The timestamp administration system according to claim 5, further comprising:
a granting number counting section which counts the number of times of acquiring timestamp information by the timestamp information acquiring section with respect to each of the ID information acquired by the ID information acquiring section, wherein
the controlling section causes the approval requesting section to request the approval, and causes the timestamp information acquiring section to acquire the timestamp information in response to receiving the approval if it is judged that the number of times of acquiring timestamp information counted by the granting number counting section is smaller than a predetermined number.

7. An image forming apparatus comprising:
a timestamp information acquiring section which acquires timestamp information via a network from a timestamp organization of verifying the time;
an approval requesting section which requests approval of acquiring the timestamp information by the timestamp information acquiring section;
an approval party information storage which stores information relating to a party to which the approval is requested by the approval requesting section; and
a controlling section which causes the approval requesting section to request the approval party stored in the approval party information storage of the approval, and causes the timestamp information acquiring section to acquire the timestamp information if it is judged that the approval requesting section has received the approval from the approval party.

8. The image forming apparatus according to claim 7, further comprising:
a data input accepting section which accepts input of data;
a data storage which stores the data accepted by the data input accepting section; and
a designation accepting section which accepts designation relating to processing of the data, wherein
the controlling section causes the approval requesting section to request the approval, causes the timestamp information acquiring section to acquire the timestamp information in response to receiving the approval, and causes the data storage to store the data with the acquired timestamp information being attached thereto if it is judged that the designation accepting section has accepted the designation to store the data in the data storage.

9. The image forming apparatus according to claim 8, further comprising:
a confirmation message outputting section which outputs a confirmation message indicating that the data with the timestamp information being attached thereto is stored in the data storage, wherein
the controlling section causes the confirmation message outputting section to output the confirmation message if it is judged that the data with the timestamp information being attached thereto is stored in the data storage.

10. The image forming apparatus according to claim 7, further comprising:
a data storage which stores data;
a data outputting section which outputs the data stored in the data storage; and
a designation accepting section which accepts designation relating to processing of the data, wherein
the controlling section causes the approval requesting section to request the approval, causes the timestamp information acquiring section to acquire the timestamp information in response to receiving the approval, and causes the data outputting section to output the data with the acquired timestamp information being attached thereto if it is judged that the designation accepting section has accepted the designation to output the data stored in the data storage by the data outputting section.

11. The image forming apparatus according to claim 7, further comprising:
an ID information acquiring section which acquires ID information for identifying a user based on an external output by the user; and
an ID information storage which stores the one or more ID information for which request of the approval by the approval requesting section is required, wherein
the controlling section causes the approval requesting section to request the approval, and causes the timestamp information acquiring section to acquire the timestamp information in response to receiving the approval if it is judged that the ID information acquired by the ID information acquiring section is stored in the ID information storage.

12. The image forming apparatus according to claim 11, further comprising:
a granting number counting section which counts the number of times of acquiring timestamp information by the timestamp information acquiring section with respect to each of the ID information acquired by the ID information acquiring section, wherein
the controlling section causes the approval requesting section to request the approval, and causes the timestamp information acquiring section to acquire the timestamp information in response to receiving the approval if it is judged that the number of times of acquiring timestamp information counted by the granting number counting section is smaller than a predetermined number.
